(19) United States
(12) Patent Application Publication
(10) Pub. No.: US 2024/0425676 A1
(43) Pub. Date: Dec. 26, 2024

(54) FIBER REINFORCED COMPOSITE MATERIAL

(71) Applicant: HONDA MOTOR CO., LTD., Tokyo (JP)

(72) Inventor: Mitsuharu KAN, Wako-shi (JP)

(21) Appl. No.: 18/752,137

(22) Filed: Jun. 24, 2024

(30) Foreign Application Priority Data
Jun. 26, 2023 (JP) 2023-104021

(51) Int. Cl. C08K 7/14; C08J 5/04

(52) U.S. Cl. CPC C08K 7/14; C08J 5/043; C08J 2363/00; C08J 2463/00

(57) ABSTRACT

A fiber reinforced composite material includes a matrix resin constructed by combination of an alicyclic epoxy compound and an epoxidized vegetable oil. The alicyclic epoxy compound has at least one cyclic aliphatic group with 4 to 7 members in a molecule, and at least two epoxy groups in the molecule. The epoxidized vegetable oil is obtained by epoxidizing an unsaturated group in the vegetable oil. A content rate (or a bio ratio) of the epoxidized vegetable oil in the matrix resin is in a range from 5% to 25%.

### CROSS-REFERENCE TO RELATED APPLICATIONS

This application is based upon and claims the benefit of priority from Japanese Patent Application No. 2023-104021 filed on Jun. 26, 2023; the entire contents of which are incorporated herein by reference.

### BACKGROUND OF DISCLOSURE

### 1. Technical Field

The present disclosure relates to a fiber reinforced composite material.

### 2. Description of Related Art

Recently, an effort is actively made for providing easy accessibility to a sustainable transportation system in consideration with even vulnerable people such as elderly persons, disabled persons and children, especially among traffic participants. Directed to realization of the effort, research and development have been focused on more improvement of traffic safety and accessibility through development in ensuring rigidity of a vehicle body.

Nowadays, demands for a fiber reinforced composite material are increased, which can contribute to weight reduction of a vehicle body and provide the vehicle body with excellent rigidity.

A fiber reinforced composite material applicable to vehicle members is known as fiber reinforced plastics containing a reinforcing fiber in a cured product of a resin composition containing a bisphenol F-type epoxy resin (e.g., see Japanese Unexamined Patent Publication No. 2006-265434). According to the above fiber reinforced plastics, productivity of vehicle members using the above fiber reinforced plastics can be improved because the bisphenol F-type epoxy resin is cured at a relatively low temperature.

### SUMMARY OF DISCLOSURE

Here, vehicle members have been investigated focusing on development of members made of environment-friendly materials in addition to productivity thereof.

Therefore, considered is replacing a part of cured components by a component derived from plant in a fiber reinforced composite material. That is, increasing a so-called bio ratio is considered.

However, a conventional fiber reinforced composite material (e.g., Japanese Unexamined Patent Application Publication No. 2006-265434) has a disadvantage such that increasing a bio ratio greatly increases flexibility, resulting in failure that those conventional materials cannot exert rigidity applicable to vehicle members.

Thus, an object of the present disclosure is to provide a fiber reinforced composite material which not only contains environment-friendly materials but also exerts excellent rigidity. Herein, this fiber reinforced composite material must contribute to development of a sustainable transportation system.

A fiber reinforced composite material which has achieved the above object of the present disclosure includes a matrix resin constructed by combination of an alicyclic epoxy compound and an epoxidized vegetable oil.

According to the present disclosure, it is possible to provide a fiber reinforced composite material exerting excellent strength while containing environment-friendly materials.

### BRIEF DESCRIPTION OF DRAWINGS

FIG. 1 is a graphic diagram illustrating a relationship between a bio ratio (%) and strength (MPa) of a cured product of a matrix resin containing an alicyclic epoxy resin and an epoxidized vegetable oil.

FIG. 2 is a graphic diagram illustrating a relationship between a bio ratio (%) and elastic modulus (MPa) of a cured product of a matrix resin containing an alicyclic epoxy resin and an epoxidized vegetable oil.

FIG. 3 is a graphic diagram illustrating a relationship between a bio ratio (%) and strength (MPa) of a fiber reinforced composite material of the present disclosure.

### DESCRIPTION OF EMBODIMENTS

Hereinafter, embodiments for carrying out a fiber reinforced composite material of the present disclosure will be described in detail.

The fiber reinforced composite material of the present embodiment is constructed to contain a cured material of a matrix resin including an alicyclic epoxy compound and an epoxidized vegetable oil, and a reinforcing fiber.

That is, the alicyclic epoxy compound is supposed which includes an at least one cyclic aliphatic group having 4 to 7 ring members in a molecule, and at least two epoxy groups in the molecule. More specifically, supposed is an alicyclic epoxide compound produced by epoxidizing a compound having a cycloalkane ring.

A compound used for the alicyclic epoxy compound may have two or more alicyclic epoxy groups such as a 3,4-epoxy cyclohexyl group.

Further, the alicyclic epoxy groups in the alicyclic epoxy compound may bind each other via a single bond or a linker.

The linker that binds the alicyclic epoxy groups each other, is not specifically limited, and includes, for example, a bivalent hydrocarbon group, a carbonyl group (—CO—), an ether linkage (—O—), an ester linkage (—COO—), a carbonate linkage (—OCOO—) and a combination thereof. The bivalent hydrocarbon group includes, for example, a linear or branched alkylene group having 1 to 6 carbon atoms, or a bivalent alicyclic hydrocarbon group.

Examples of the alicyclic epoxy compound include, for example, 3,4-epoxycyclohexylmethyl (3,4-epoxy) cyclohexane carboxylate, tetrahydroindene diepoxide, 1-methyl-4-(2-methyloxiranyl)-7-oxabicyclo[4.1.0]heptane, 1,3-bis(N,N-diglycidyl aminomethyl)cyclohexane, bis(3,4-epoxycyclohexylmethyl) adipate, 3,4,3′,4′-diepoxybicyclohexyl, dicyclopentadiene dioxide, bis(2,3-epoxycyclopentyl) ether, etc., but are not limited thereto.

Among the above compounds, preferably the alicyclic epoxy compound is a compound in which an existence ratio of a cyclic structure in a molecule is one per 140 or less of a molecular weight of the alicyclic epoxy compound. In other words, a total atomic amount of the carbon atoms and hydrogen atoms constructing the above cyclic aliphatic group (or carbon atoms, hydrogen atoms and oxygen atoms in case of an alicyclic epoxy group) is calculated and converted to a molecular weight of the cyclic aliphatic group. Namely, when converting the total atomic amount of the cyclic aliphatic group thus calculated as the molecular weight of the cyclic aliphatic group, preferably the alicyclic epoxy compound has at least one cyclic aliphatic group per 140 of the molecular weight in the alicyclic epoxy compound.

Further, preferably the alicyclic epoxy compound has an epoxy equivalent of 194 (g/eq) or less. Here, the epoxy equivalent represents a mass (g/eq) of a resin including a 1 gram equivalent epoxy group.

Further, preferably the alicyclic epoxy compound has two or more functional groups.

Further, preferably the alicyclic epoxy compound is a liquid at ambient temperature (25° C.).

The alicyclic epoxy compound mentioned above can be used alone or in combination of 2 or more kinds.

It is noted that a commercially available compound can be used for the alicyclic epoxy compound.

More specifically, the commercially available compounds include, for example, 3,4-epoxycyclohexylmethyl (3,4-epoxy)cyclohexane carboxylate (CEL2021P produced by Daicel Corporation [viscosity: 250 m Pa·s, epoxy equivalent: 130 g/eq]), tetrahydroindene diepoxide (THI-DE produced by ENEOS Corporation [viscosity: 20 m Pa·s, epoxy equivalent: 80 g/eq]), 1-methyl-4-(2-methyloxiranyl)-7-oxabicyclo[4.1.0]heptane (limonene dioxide produced by ARKEMA [viscosity: 200 m Pa·s, epoxy equivalent: 84 g/eq]) or the like.

An epoxidized vegetable oil can be available, for example, by epoxidizing a vegetable oil.

The vegetable oil includes, for example, a soybean oil, a linseed oil, a sunflower oil, a tung oil, a castor oil, a corn oil, a rapeseed oil, a sesame oil, an olive oil, a palm oil, a grape seed oil, a rice bran oil, a cotton seed oil, and a safflower oil or the like, but is not limited thereto.

The epoxidized vegetable oil can be obtained by epoxidizing an unsaturated group of unsaturated fatty acid triglyceride of glycerol. There are not many triglycerides composed of only the same fatty acid in natural fat and oil. The natural fat and oil are rather composed of a plurality of fatty acids.

A commercially available product can be used for the epoxidized vegetable oil. The commercially available epoxidized vegetable oil includes, for example, the epoxidized soybean oil (AdekaCizer O-130P produced by ADEKA), and the epoxidized linseed oil (AdekaCizer O-180A produced by ADEKA) or the like.

It is possible to further include a curing agent and a curing accelerator in a matrix resin containing the above described alicyclic epoxy compound and epoxidized vegetable oil.

The curing agent includes, for example, polyamine compounds such as diethylenetriamine, triethylenetetramine, diaminodiphenyl methane, m-phenylenediamine, dicyandiamide; polyphenol compounds such as bisphenol A, phenol novolac resin, cresol novolac resin, bisphenol A novolac resin, phenol aralkyl resin; acid anhydrides such as phthalic acid anhydride, pyromellitic acid anhydride; carboxylic acid compounds; and active ester compounds or the like.

The curing accelerator includes, for example, an imidazole based curing accelerator, a tertiary amine based curing accelerator, and a phosphor based curing accelerator or the like.

The reinforcing fiber includes, for example, a glass fiber, a carbon fiber, a polyester fiber, a polyamide fiber and an aluminum fiber or the like.

Next, a method for producing a fiber reinforced composite material of the present embodiment will be described in detail.

The method for producing a fiber reinforced composite material mainly includes a step for preparing a matrix resin, and a step for molding a fiber reinforced composite material in a predetermined mold by curing the matrix resin containing a reinforcing fiber.

In the step for preparing the matrix resin, an alicyclic epoxy compound, an epoxidized vegetable oil, a curing agent and a curing accelerator are mixed and degassed.

Desirably a content ratio (or a bio ratio) of the epoxidized vegetable oil in the matrix resin is set in 5 mass % or more and 25 mass % or less. Setting the bio ratio of the matrix resin as mentioned above can not only reduce environmental loads more effectively than conventional resins but provide a cured product of the matrix resin with good bending strength and good bending elastic modulus.

Here, preferably a mass rate (B/A) of the epoxidized vegetable oil (B) per the alicyclic epoxy compound (A) is set to more than 0 and 1.2 or less.

A mixing amount of the curing agent in the matrix resin may be set to 40 or more and 60 or less parts by mass.

A mixing amount of the curing accelerator in the matrix resin may be set to 0 or more and 3 or less parts by mass per a total mass of the matrix resin of 100 parts by mass.

A variety of known methods may be applied to a method for molding the fiber reinforced composite material using the above matrix resin corresponding to targeted use and functions of the fiber reinforced composite material.

The method for molding the fiber reinforced composite material may be a method for molding a prepreg prepared by impregnating beforehand a matrix resin composite into a reinforcing fiber, that is, like a WET press molding method. Further, the method for molding the fiber reinforced composite material may be a method for combining the reinforcing fiber with the matrix resin composition at the same time of molding, such as a resin transfer molding method and a resin film infusion molding method.

A mass rate of the reinforcing fiber to the matrix resin in the fiber reinforced composite material in the present embodiment is supposed to be 1:1, but the mass rate is not limited thereto.

This fiber reinforced composite material in the present embodiment can be used for a material of components of a mobile body such as a vehicle, a marine vessel and an aircraft. In particular, the fiber reinforced composite material can be preferably used for vehicle members.

### Effects of Disclosure

Next, effects exerted by the fiber reinforced composite material according to the present embodiment will be described in detail.

The fiber reinforced composite material of the present embodiment includes a matrix resin constructed by combination of an alicyclic epoxy compound and an epoxidized vegetable oil.

The fiber reinforced composite material of the present embodiment is composed of an environment-friendly material by including the epoxidized vegetable oil, i.e., with keeping carbon neutral in mind. Further, the fiber reinforced composite material of the present embodiment can achieve both reduction of environmental loads and maintenance of good strength applicable to components because of a synergetic effect of the alicyclic epoxy compound having rigidity in a molecular skeleton and the epoxidized vegetable oil providing toughness with the fiber reinforced composite material.

Further, preferably the fiber reinforced composite material of the present embodiment has an existence ratio of a cyclic structure in the alicyclic epoxy compound with one per a molecular weight of 140 or less.

The above fiber reinforced composite material can keep rigidity of a molecular skeleton, leading to realization of more excellent strength.

Moreover, preferably the fiber reinforced composite material of the present embodiment has an epoxy equivalent of 194 (g/eq) or less in the alicyclic epoxy compound.

The above fiber reinforced composite material can more increase crosslink density, allowing more excellent strength to be realized.

Furthermore, according to the fiber reinforced composite material of the present embodiment, preferably the alicyclic epoxy compound is a multifunctional epoxy compound, and a 3-dimensional crosslinking therein has a structure with 2 or more functional groups.

The above fiber reinforced composite material can realize more excellent strength due to the 3-dimensional crosslinking structure.

Further, the alicyclic epoxy compound of the fiber reinforced composite material of the present embodiment is preferably a liquid at an ambient temperature in an uncured state.

The above fiber reinforced composite material can provide flowability with an uncured matrix resin. Therefore, this fiber reinforced composite material can be produced efficiently by resin transfer molding method (RTM method) and WET press molding method. Accordingly, this feature more improves cost performance and productivity of the fiber reinforced composite material.

Furthermore, according to the fiber reinforced composite material of the present embodiment, a bio ratio of the epoxidized vegetable oil in the matrix resin is preferably in a range from 5 mass % to 25 mass %.

The above fiber reinforced composite material can more effectively reduce environmental loads and maintain good strength applicable to components.

As describe hereinbefore, the fiber reinforced composite material of the present embodiment can be preferably used for members for vehicle or the like.

### EXAMPLES

Next, example and comparative examples verifying effects exerted by the fiber reinforced composite material of the present embodiment will be explained in detail.

### Example 1

In the present example, 3,4-epoxycyclohexylmethyl (3,4-epoxy) cyclohexane carboxylate (CEL2021P manufactured by DAICEL) was prepared as an alicyclic epoxy compound. The alicyclic epoxy compound had two cyclic structures, a molecular weight of 252, and a viscosity of 250 mPa·s (at 25° C.). An epoxy equivalent thereof was 130 (g/eq). Further, an epoxidized soybean oil (AdekaCizer O-130P manufactured by ADEKA) was prepared as an epoxidized vegetable oil.

Next, a liquid matrix resin with a bio ratio of 25 mass % was prepared by mixing the alicyclic epoxy compound of 26 parts by mass, the epoxidized vegetable oil of 25 parts by mass, a curing agent of 49 parts by mass, and a curing accelerator of 1 parts by mass. Here, as for the curing agent, methyl-3,6-endomethylene-1, 2, 3, 6-tetrahydrophthalic anhydride (MHAC-P manufactured by Showa Denko Materials) was used. As for the curing accelerator, tris(dimethylaminomethyl) phenol (DMP-30 manufactured by Nacalai Tesque, Inc.) was used.

After performing vacuum degassing for the matrix resin, the matrix resin was injected in a mold having a thin shaped cavity with a thickness of 2 mm, and cured. A curing temperature thereof was 140° C. and a curing time thereof was 2 hrs.

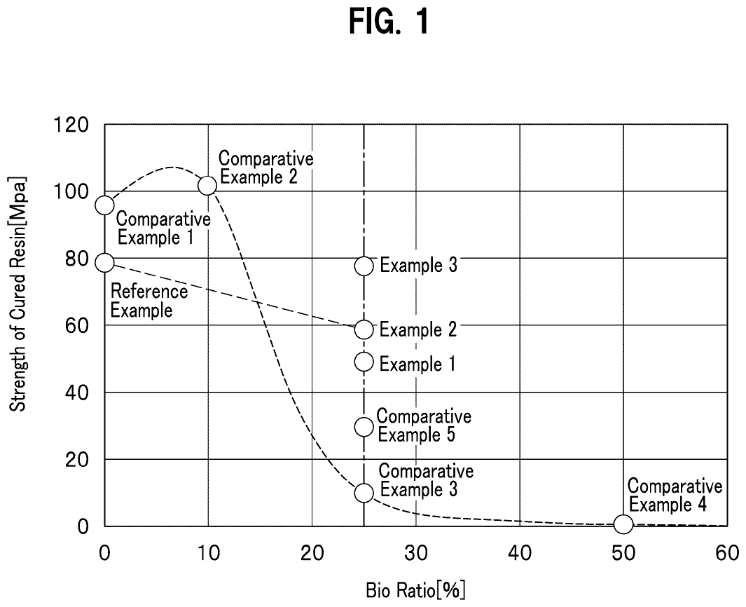

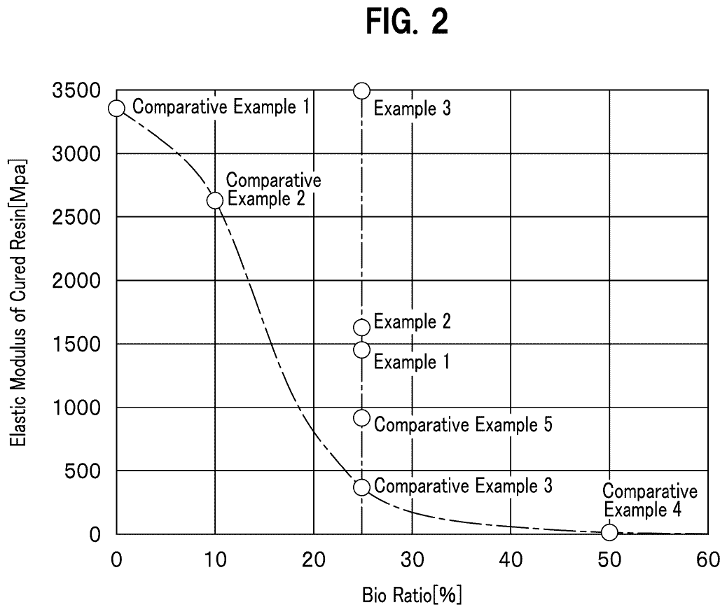

A cured product of the matrix resin was evaluated by a bending strength measuring test and a bending elastic modulus measuring test. The bending strength measuring test and the bending elastic modulus measuring test were performed based on JIS K7171. As a result, the bending strength of the cured product was 47 MPa and the bending elastic modulus was 1471 MPa. The results were shown in Table 1, FIGS. 1 and 2.

TABLE 1

| | | | bio | cured resin | cured resin | FRP |
|---|---|---|---|---|---|---|
| | | | ratio | elastic ratio | strength | strength |
| | | | (%) | (Mpa) | (Mpa) | (Mpa) |
| Example 1 | epoxidized | alicyclic epoxy | 25 | 1,471 | 47 | 457 |
| | soybean oil | compound | | | | |
| Example 2 | epoxidized | alicyclic epoxy | 25 | 1,638 | 59 | 520 |
| | soybean oil | compound | | | | |
| Example 3 | epoxidized | alicyclic epoxy | 25 | 3,481 | 77 | 652 |
| | linseed oil | compound | | | | |
| Comparative | — | bisphenol A-type | 0 | 3,391 | 96 | 927 |
| Example 1 | | epoxy compound | | | | |
| Comparative | epoxidized | bisphenol A-type | 10 | 2,658 | 101 | 810 |
| Example 2 | soybean oil | epoxy compound | | | | |
| Comparative | epoxidized | bisphenol A-type | 25 | 411 | 10 | 319 |
| Example 3 | soybean oil | epoxy compound | | | | |
| Comparative | epoxidized | bisphenol A-type | 50 | 10 | — | 7 |
| Example 4 | soybean oil | epoxy compound | | | | |
| Comparative | epoxidized | bisphenol A-type | 25 | 924 | 30 | 330 |
| Example 5 | linseed oil | epoxy compound | | | | |
| Reference | epoxidized | alicyclic epoxy | 0 | 3,594 | 78 | 665 |
| Example | soybean oil | compound | | | | |

Next, a fiber reinforced composite material was produced by using the above uncured matrix resin.

At the step of producing the fiber reinforced composite material, first, glass cloth (WR570 manufactured by Owens Corning, LLC) thus prepared as a reinforcing fiber was stacked into five layers.

The glass cloth thus stacked was impregnated with the matrix resin having the same weight as of the glass cloth by applying the matrix resin to the glass cloth.

After performing vacuum degassing of the glass cloth including the matrix resin, the glass cloth was clamped in a mold having a thin shaped cavity with a thickness of 2 mm, and cured to produce a fiber reinforced composite material (hereinafter, the material is referred to FPR: Fiber Reinforced Plastics). A curing temperature thereof was 140° C. and a curing time thereof was 2 hrs.

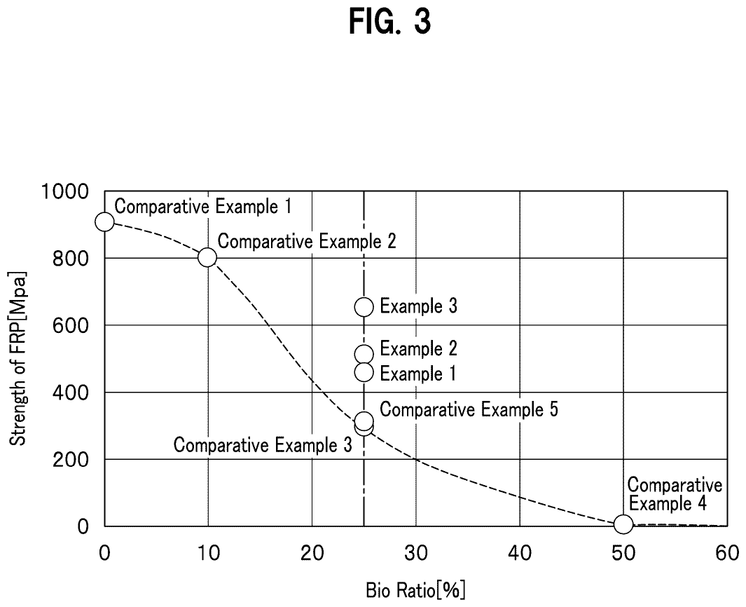

The fiber reinforced plastics (FRP) were evaluated in the bending strength measuring test as conducted hereinbefore. Bending strength of the fiber reinforced plastics (FRP) was 457 MPa. Table 1 and FIG. 3 illustrate the results of the test.

### Example 2

An alicyclic epoxy compound; tetrahydroindene diepoxide (TH1-DE manufactured by ENEOS) of 24 parts by mass was used by replacing the alicyclic epoxy compound of Example 1; 3,4-epoxycyclohexylmethyl (3,4-epoxy)cyclohexane carboxylate of 26 parts by mass. Additionally, a usage amount of the curing agent was changed from 49 parts by mass to 50 parts by mass. Except for the above described changes, a liquid matrix resin having a bio ratio of 25 mass % was prepared the same as Example 1.

Here, tetrahydroindene diepoxide has two cyclic structures, a molecular weight of 154, viscosity of 20 mPa·s (at 25° C.) an epoxy equivalent thereof is 80 (g/eq).

Except for using the above described matrix resin, a molded body of the cured product and fiber reinforced plastics (FRP) were prepared the same as Example 1.

The bending strength of the cured product was 59 MPa and the bending elastic modulus thereof was 1638 MPa. The results were shown in Table 1, FIGS. 1 and 2. The bending strength of the fiber reinforced plastics (FRP) was 520 MPa. Table 1 and FIG. 3 illustrate the results.

### Example 3

A usage amount of the alicyclic epoxy compound of Example 1; 3,4-epoxycyclohexylmethyl (3,4-epoxy)cyclohexane carboxylate was changed from 26 parts by mass to 22 parts by mass. Further, the epoxidized linseed oil (AdekaCizer O-180A produced by ADEKA) of 25 parts by mass was used by replacing the epoxidated vegetable oil of Example 1: epoxidized soybean oil of 25 parts by mass. Moreover, a usage amount of the curing agent was changed from 49 parts by mass to 52 parts by mass. Except for the above described changes, a liquid matrix resin having a bio ratio of 25 mass % was prepared the same as Example 1.

Except for using the above described matrix resin, a molded body of the cured product and fiber reinforced plastics (FRP) were prepared the same as Example 1.

The bending strength of the cured product was 77 MPa and the bending elastic modulus thereof was 3481 MPa. The results were shown in Table 1, FIGS. 1 and 2. The bending strength of the fiber reinforced plastics (FRP) was 652 MPa. Table 1 and FIG. 3 illustrate the results.

### Comparative Example 1

Bisphenol A-type epoxy compound (828 manufactured by Mitsubish Chemical, (epoxy equivalent of 192) of 52 parts by mass was used by replacing the alicyclic epoxy compound of Example 1; 3,4-epoxycyclohexylmethyl (3,4-epoxy)cyclohexane carboxylate of 26 parts by mass. An epoxidized vegetable oil was not used. Additionally, a usage amount of the curing agent was changed from 49 parts by mass to 48 parts by mass. Except for those changes, a liquid matrix resin having a bio ratio of 0 mass % was prepared the same as Example 1.

Except for using the above described matrix resin, a molded body of the cured product and fiber reinforced plastics (FRP) were prepared the same as Example 1.

The bending strength of the cured product was 96 MPa and the bending elastic modulus thereof was 3391 MPa. The results were shown in Table 1, FIGS. 1 and 2. The bending strength of the fiber reinforced plastics (FRP) was 927 MPa. Table 1 and FIG. 3 illustrate the results.

### Comparative Example 2

Bisphenol A-type epoxy compound (828 manufactured by Mitsubish Chemical, (epoxy equivalent of 192) of 43 parts by mass was used by replacing the alicyclic epoxy compound of Example 1; 3,4-epoxycyclohexylmethyl (3,4-epoxy)cyclohexane carboxylate of 26 parts by mass. A usage amount of the epoxidized vegetable oil of Example 1: epoxidized soybean oil was changed from 25 parts by mass to 10 parts by mass. Additionally, a usage amount of the curing agent was changed from 49 parts by mass to 46 parts by mass. Except for those changes, a liquid matrix resin having a bio ratio of 10 mass % was prepared the same as Example 1.

Except for using the above described matrix resin, a molded body of the cured product and fiber reinforced plastics (FRP) were prepared the same as Example 1.

The bending strength of the cured product was 101 MPa and the bending elastic modulus thereof was 2658 MPa. The results were shown in Table 1, FIGS. 1 and 2. The bending strength of the fiber reinforced plastics (FRP) was 810 MPa. Table 1 and FIG. 3 illustrate the results.

### Comparative Example 3

Bisphenol A-type epoxy compound (828 manufactured by Mitsubish Chemical, (epoxy equivalent of 192) of 29 parts by mass was used by replacing the alicyclic epoxy compound of Example 1; 3,4-epoxycyclohexylmethyl (3,4-epoxy)cyclohexane carboxylate of 26 parts by mass. Additionally, a usage amount of the curing agent was changed from 49 parts by mass to 45 parts by mass. Except for those changes, a liquid matrix resin having a bio ratio of 25 mass % was prepared the same as Example 1.

Except for using the above described matrix resin, a molded body of the cured product and fiber reinforced plastics (FRP) were prepared the same as Example 1.

The bending strength of the cured product was 10 MPa and the bending elastic modulus thereof was 411 MPa. The results were shown in Table 1, FIGS. 1 and 2. The bending strength of the fiber reinforced plastics (FRP) was 319 MPa. Table 1 and FIG. 3 illustrate the results.

### Comparative Example 4

Bisphenol A-type epoxy compound (828 manufactured by Mitsubish Chemical, (epoxy equivalent of 192) of 7 parts by mass was used by replacing the alicyclic epoxy compound of Example 1; 3,4-epoxycyclohexylmethyl (3,4-epoxy)cyclohexane carboxylate of 26 parts by mass. A usage amount of the epoxidized vegetable oil of Example 1: epoxidized soybean oil was changed from 25 parts by mass to 50 parts by mass. Additionally, a usage amount of the curing agent was changed from 49 parts by mass to 43 parts by mass. Except for those changes, a liquid matrix resin having a bio ratio of 50 mass % was prepared the same as Example 1.

Except for using the above described matrix resin, a molded body of the cured product and fiber reinforced plastics (FRP) were tried to be prepared the same as Example 1.

However, the resulting matrix resin was not sufficiently cured. Therefore, it was impossible to measure the bending strength of the product. The bending elastic modulus thereof was 10 MPa. The results were shown in Table 1, FIGS. 1 and 2. The bending strength of the fiber reinforced plastics (FRP) was 7 MPa. Table 1 and FIG. 3 illustrate the results.

### Comparative Example 5

Bisphenol A-type epoxy compound (828 manufactured by Mitsubish Chemical, (epoxy equivalent of 192) of 27 parts by mass was used by replacing the alicyclic epoxy compound of Example 1; 3,4-epoxycyclohexylmethyl (3,4-epoxy)cyclohexane carboxylate of 26 parts by mass. Additionally, a usage amount of the curing agent was changed from 49 parts by mass to 48 parts by mass. Except for those changes, a liquid matrix resin having a bio ratio of 25 mass % was prepared the same as Example 1.

Except for using the above described matrix resin, a molded body of the cured product and fiber reinforced plastics (FRP) were prepared the same as Example 1.

The bending strength of the cured product was 30 MPa and the bending elastic modulus thereof was 924 MPa. The results were shown in Table 1, FIGS. 1 and 2. The bending strength of the fiber reinforced plastics (FRP) was 330 MPa. Table 1 and FIG. 3 illustrate the results.

### Reference Example

A usage amount of the alicyclic epoxy compound of Example 2:3,4-epoxycyclohexylmethyl (3,4-epoxy)cyclohexane carboxylate was changed from 24 parts by mass to 47 parts by mass. No epoxidized vegetable oil was used. Additionally, a usage amount of the curing agent was changed from 50 parts by mass to 52 parts by mass. Except for those changes, a liquid matrix resin having a bio ratio of 0 mass % was prepared the same as Example 2.

Except for using the above described matrix resin, a molded body of the cured product and fiber reinforced plastics (FRP) were prepared the same as Example 2.

Table 1 and FIG. 1 illustrate the results.

### (Evaluation of Fiber Reinforced Plastics)

As illustrated in Table 1, FIGS. 1 to 3, cured compounds containing the alicyclic epoxy compounds of Examples 1 to 3, demonstrated good bending strength and bending elastic modulus, even at the bio ratio of 25 mass %: a certification standard of Japan BioPlastics Association (JBPA). Further, the fiber reinforced plastics containing those matrix resins and reinforcing fibers demonstrated good bending elastic modulus.

On the other hand, the matrix resins and the fiber reinforced plastics of Comparative Examples 3 and 5 containing the bisphenol A-type epoxy compound instead of the alicyclic epoxy compound indicated both insufficient bending strength and bending elastic modulus. Here, it should be particularly noted that the bending elastic modulus of the fiber reinforce plastics in Example 2 indicated 4-fold higher than the bending elastic modulus of the fiber reinforced plastics in Comparative Example 3. Further, when comparing Example 3 to Comparative Example 5 both of which use the epoxidized linseed oil, the bending elastic modulus of the fiber reinforced plastics of Example 3 indicated 3.8-fold higher than the bending elastic modulus of the fiber reinforced plastics of Comparative Example 5.

As described hereinbefore, it was demonstrated that the fiber reinforced composite material or fiber reinforced plastics (FRP) achieves both reduction of environmental loads and realization of good strength.

As mentioned above, the embodiments of the present disclosure have been described. However, the present disclosure is not limited to those embodiments and various modifications can be performed.

What is claimed is:

1. A fiber reinforced composite material, comprising:
a matrix resin including a combination of an alicyclic epoxy compound and an epoxidized vegetable oil.

2. The fiber reinforced composite material according to claim 1, wherein an existence ratio of a cyclic structure in the alicyclic epoxy compound is one per a molecular weight of 140 or less.

3. The fiber reinforced composite material according to claim 1, wherein an epoxy equivalent of the alicyclic epoxy resin is 194 (g/eq) or less.

4. The fiber reinforced composite material according to claim 1, wherein the alicyclic epoxy compound is a multi-functional epoxy compound, and a 3-dimensional cross-linker has two functional groups or more.

5. The fiber reinforced composite material according to claim 1, wherein the alicyclic epoxy compound is a liquid at an ambient temperature in an uncured state.

6. The fiber reinforced composite material according to claim 1, wherein a bio ratio determined by a content rate of the epoxidized vegetable oil in the matrix resin is in a range from 5% to 25%.

7. The fiber reinforced composite material according to claim 1, wherein the fiber reinforced composite material is used for a vehicle member.
